(19) United States
(12) Patent Application Publication
(10) Pub. No.: US 2024/0275705 A1
(43) Pub. Date: Aug. 15, 2024

(54) DETERMINATION DEVICE AND DETERMINATION METHOD

(71) Applicant: Nippon Telegraph and Telephone Corporation, Tokyo (JP)

(72) Inventors: Kenichi AOYAGI, Musashino-shi, Tokyo (JP); Sachio SUDA, Musashino-shi, Tokyo (JP)

(21) Appl. No.: 18/561,349

(22) PCT Filed: May 21, 2021
(86) PCT No.: PCT/JP2021/019442

§ 371 Date: Nov. 16, 2023

(51) Int. Cl. H04L 43/091; G06F 3/0484; H04L 43/106

(52) U.S. Cl. CPC H04L 43/091; G06F 3/0484; H04L 43/106

(57) ABSTRACT

A component determination system includes a checker module unit that supplies power to a DUT being connected, and a normality determination unit that transmits and receives inspection data to and from the DUT via the checker module unit. The checker module unit includes a connector conversion unit and a power conversion unit, and the normality determination unit receives inspection data indicating that the DUT has been activated by supplying power to the DUT, and causes a GUI to display a fact that the DUT has been activated.

### TECHNICAL FIELD

The present invention relates to a determination device and a determination method.

### BACKGROUND ART

There has been proposed a method for determining normality (whether an electronic component normally operates without failure) of an electronic component which is a measurement target (device under test (DUT)).

Non Patent Literature 1 describes an example of an IC checker that inspects connected electronic components as a tool for developers. This IC checker inputs a digital data array including 0, 1 to an IC as a DUT, and checks whether an output result of the digital data array from the IC including 0, 1 is as expected.

Non Patent Literature 2 describes an example in which an operating state is displayed by an LED lamp included in an electronic component itself.

### CITATION LIST

### Non Patent Literature

Non Patent Literature 1: AliExpress, “Original digital tester 74 series 40 series 45 series ic logic gate test precision integrated circuit checker”, [online], [searched on May 6, 2021], Internet <URL:https://ja.aliexpress.com/item/32947776604.html?src=go ogle&albch=shopping&acnt=494-037-6276&isdl=y&slnk=&plac=&mtctp=&albbt=Google_7_shopping&aff_platform=google&aff_short key=UneMJZVf&&albagn=888888&isSmb AutoCall=false&needSmbHouyi=false&albcp=9444659500&albag=96 168745579&trgt=539263010115&crea=ja32947776604&netw=u&devic e=c&albpg=539263010115&albpd=ja32947776604&gclid=EAIaIQobCh MIk8GA9a7m7wIVVQVgChlgyQO2EAkYBCABEgI2t_D_BwE&gclsrc=aw.ds>Non Patent Literature 2: ELECOM, “Q. Meaning of the lamp (LED)/When the lamp (LED) does not emit light”, [online], [searched on May 6, 2021], Internet <URL:http://qa.elecom.co.jp/faq_detail.html?id=8067>

### SUMMARY OF INVENTION

### Technical Problem

In order to shorten the interruption time of the communication service and continue the communication service even when a component fails, it is desirable to always prepare a spare electronic component (package (PKG)), which is a replacement component, in a maintenance base. Then, when the PKG used in a communication device in a local environment actually fails, a maintenance person carries the spare PKG in the maintenance base to the local environment as a replacement PKG.

Since the replacement PKG may also be broken, the normality is confirmed at the time of replacement. That is, the replacement PKG is also a normality measurement target.

In a conventional technology, a maintenance person carries a replacement PKG from a maintenance base to a local environment, and mounts the replacement PKG on a communication device in the local environment to confirm normality. However, when an abnormality is found in the replacement PKG in the local environment, it takes time and effort to return to the maintenance base again and carry the replacement PKG. In addition, there has also been a case where the time required for the PKG replacement prolongs the interruption time of the communication service.

On the other hand, in order to confirm the normality of the replacement PKG in advance at the maintenance base, it is necessary to deploy a communication facility for confirmation in the maintenance base. Since this communication facility is prepared for each system and each vendor, it is very expensive. Construction work for constructing communication equipment is also required.

It is not possible to appropriately transmit the state of the replacement PKG to the maintenance person while communicating with the replacement PKG only by using the conventional IC checker such as Non Patent Literature 1 instead of the communication device in the local environment. In addition, since the power supply conditions are different for each IC, IC checkers are also required as many as the number of power supply conditions to the IC, which results in a high-cost test environment. In addition, a large communication facility used by a communication company is modularized so as to be replaceable for each part, and the check function in the DUT such as Non Patent Literature 2 needs to connect the DUT to a communication device in a local environment to supply power.

Therefore, a main object of the present invention is to confirm normality of a replacement component at low cost before carrying the replacement component to a local environment.

### Solution to Problem

In order to solve the above problem, a determination device of the present invention has the following characteristics.

The present invention is directed to a determination device including
a checker module unit that supplies power to a measurement target being connected, and
a normality determination unit that transmits and receives inspection data to and from the measurement target via the checker module unit,
in which the checker module unit includes
a connector conversion unit that converts a connector such that the checker module unit and the measurement target can be connected according to a standard of a connector used for connection to the measurement target, and
a power conversion unit that converts into a standard capable of supplying power to the measurement target according to a standard of power used by the measurement target, and
the normality determination unit receives the inspection data indicating that the measurement target has been activated by supplying power to the measurement target, and causes a display device to display a fact that the measurement target has been activated.

### Advantageous Effects of Invention

According to the present invention, it is possible to confirm normality of a replacement component at low cost before carrying the replacement component to a local environment.

### BRIEF DESCRIPTION OF DRAWINGS

FIG. 1 is a configuration diagram of a component determination system according to the present embodiment.

FIG. 2 is a hardware configuration diagram of each device in the component determination system according to the present embodiment.

FIG. 3 is a detailed configuration diagram of the component determination system according to the present embodiment.

FIG. 4 is a flowchart illustrating processing of the component determination system according to the present embodiment.

FIG. 5 is a configuration diagram illustrating details of energization confirmation processing and initial program reading processing according to the present embodiment.

FIG. 6 is a configuration diagram illustrating details of normality confirmation of unique data according to the present embodiment.

FIG. 7 is a configuration diagram illustrating details of various setting processing for a DUT and normality confirmation processing according to setting data according to the present embodiment.

### DESCRIPTION OF EMBODIMENTS

Hereinafter, one embodiment of the present invention will be described in detail with reference to the drawings.

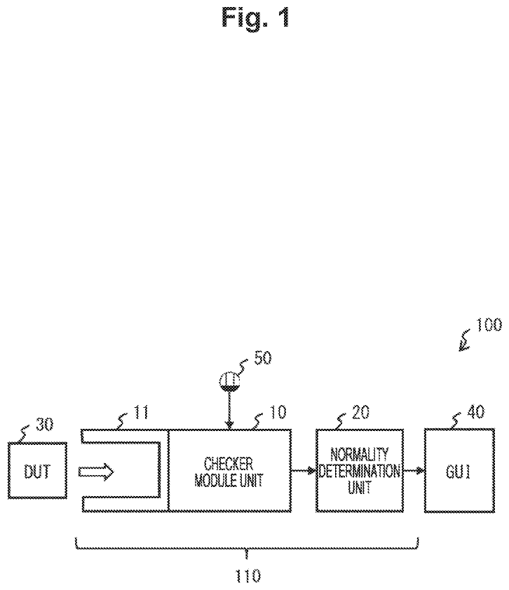

FIG. 1 is a configuration diagram of a component determination system 100.

The component determination system 100 is constructed, for example, in a place different from a local environment such as a maintenance base. As a result, normality can be confirmed before carrying a DUT 30 as a measurement target to the local environment.

The DUT 30 is replacement equipment, and may be a device such as a switch or a router, or an electronic component (PKG) mounted on the device. The DUT 30 of the electronic component is, for example, an optical module attached a box type switch or an interface card attached to a chassis type switch.

The component determination system 100 is used, for example, in the following applications.
Plant shipment inspection.
Delivery inspection/acceptance inspection.
Inspection combining a plurality of DUTs 30. This is because there are combinations of the setting data of the plurality of DUTs 30 in which failure determination cannot be performed only by checking the normality of a single DUT 30.

The component determination system 100 includes a checker module unit 10 including a connector conversion unit 11, a normality determination unit 20, a graphical user interface (GUI) 40 such as an external monitor or a light emitting diode (LED), and a power supply unit 50. The checker module unit 10 and the normality determination unit 20 may be configured as separate devices, or may be configured as an integrated determination device 110.

In order to support the inspection in which the plurality of DUTs 30 are combined, one normality determination unit 20 and a plurality of checker module units 10 may be connected.

The DUT 30 is attached to the connector conversion unit 11. The attached DUT 30 is energized from the checker module unit 10, and data is transmitted to and received from the checker module unit 10, and thereby the normality of the DUT 30 is confirmed. That is, the DUT 30 attached to the connector conversion unit 11 operates in the inspection environment as if the DUT is attached to the housing of the communication device operated in the local environment.

A first program (firmware) executed on the DUT 30 exchanges a signal with a second program executed on a communication device side in a local environment to determine the normality of the DUT 30 itself, and notifies a maintenance person of the abnormal state via the second program.

Here, since the normality determination unit 20 emulates the second program, the first program on the DUT 30 can determine the normality and notify the maintenance person of the abnormal state similarly to the second program even when a communication partner is switched from the second program in the local environment to the normality determination unit 20.

The checker module unit 10 supplies power from the power supply unit 50 to the DUT 30, and converts different standards of the DUT 30 for each vendor (or for each system) so that the same normality determination unit 20 can transmit and receive signals. As a result, normality for a plurality of vendors can be confirmed in a unified manner. The standard of the DUT 30 is, for example, a data structure, a parameter, a connector shape, a connector arrangement, and the like.

The normality determination unit 20 transmits and receives inspection data to and from the DUT 30 via the checker module unit 10, and determines normality with respect to a response from the DUT 30. The inspection data are listed below.
The power supply signal supplies power to the DUT 30 to activate the DUT 30.
The unique data is data unique to the DUT 30, and is, for example, model number information, a manufacturing number, a lot number, a firmware version, or the like.
The setting data is data set (registration and control) in the DUT 30 in order to operate the DUT 30 in a communication device in a local environment, and is, for example, parameters such as a slot number, a wavelength number, a path number, a port number, and a module type.
The response data is data indicating a response from the DUT 30 to the setting data.

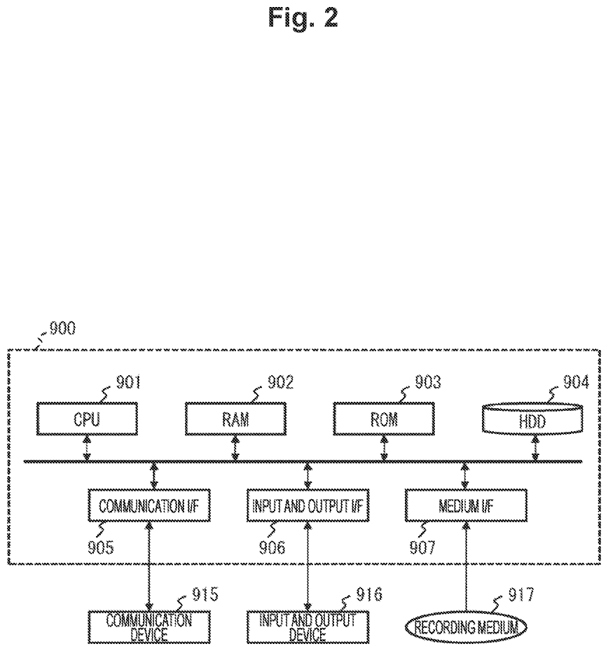

FIG. 2 is a hardware configuration diagram of each device (the checker module unit 10 and the normality determination unit 20) in the component determination system 100.

Each device of the component determination system 100 is configured as a computer 900 including a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to an input/output device 916. The medium I/F 907 reads and writes data from and to a recording medium 917. Moreover, the CPU 901 controls each processing unit by executing a program (also referred to as an application or an app for abbreviation thereof) read into the RAM 902. Then, the program can be distributed via a communication line or recorded in a recording medium 917 such as a CD-ROM and distributed.

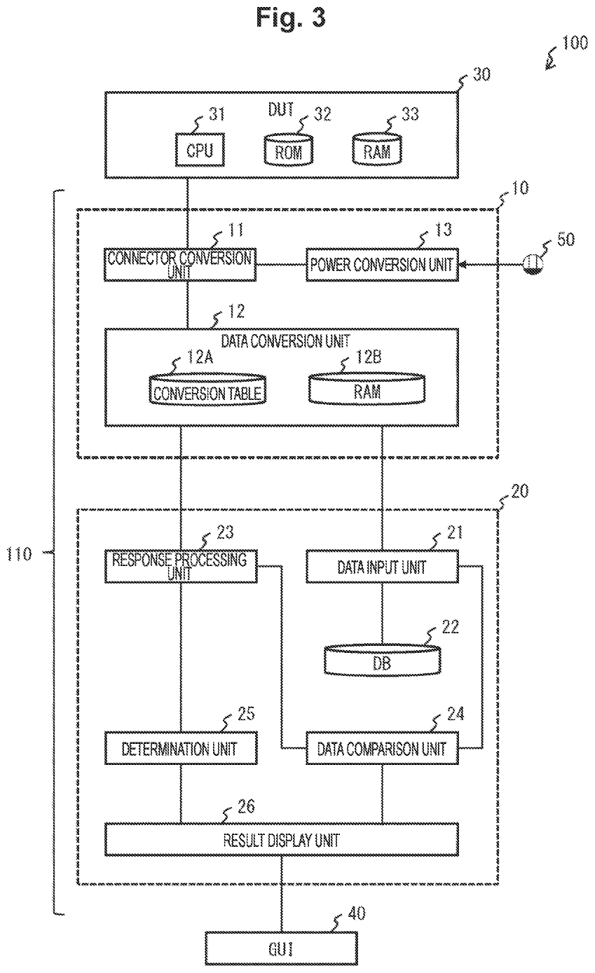

FIG. 3 is a detailed configuration diagram of the component determination system 100.

A CPU 31, a ROM 32, and a RAM 33 are mounted on the DUT 30.

The checker module unit 10 includes a connector conversion unit 11, a data conversion unit 12, and a power conversion unit 13.

The power conversion unit 13 is configured to be detachable from the checker module unit 10 in order to convert the power supplied from the power supply unit 50 into a standard that can be supplied for each DUT 30. Note that the standard of the power supply unit 50 is not limited to 100 V AC, and any standard can be adopted.

That is, since the connector conversion unit 11 and the power conversion unit 13 of the checker module unit 10 emulate the power supply circuit in the local environment, it is possible to inspect energization and activation of the DUT 30 without using a communication device in the local environment.

The connector conversion unit 11 and the power conversion unit 13 of the checker module unit 10 of the component determination system 100 are replaced for each DUT 30, but the other inspection environments (mainly the normality determination unit 20) can be commonly used by the DUTs 30 of a plurality of vendors.

The connector conversion unit 11 performs conversion so as to be connectable to the checker module unit 10 according to the standard of the connector used for connection to the DUT 30. That is, the connector conversion unit 11 performs conversion related to a physical shape such as a connector shape or pin arrangement different for each vendor of the DUT 30.

The connector conversion unit 11 is configured as, for example, an attachment (conversion adapter) detachable from the checker module unit 10. For example, when inspecting the DUT 30 manufactured by the company A, the maintenance person inserts the connector conversion unit 11 for the company A into the checker module unit 10. When thereafter inspecting the DUT 30 manufactured by the company B, the maintenance person may remove the connector conversion unit 11 for the company A from the checker module unit 10 and then replace it with the connector conversion unit 11 for the company B.

The data conversion unit 12 performs conversion related to contents of a signal such as a data structure and parameter conversion for performing data communication between the DUT 30 and the normality determination unit 20. Therefore, the data conversion unit 12 includes a conversion table 12A and a RAM 12B.

In the conversion table 12A, data such as a slot number/port number (data indicating a mounting position), an interface type, wavelength data, and path data is stored for each vendor. As the data in the conversion table 12A, for example, a case where the company A manages the mounting position data in the form of “1, 2, 3, 4, 5, 6” as the slot number and the company B manages the mounting position data in the form of “1-1, 1-2, 1-3, 1-4, 1-5, 1-6” will be described.

When relaying the inspection data transmitted and received between the DUT 30 and the normality determination unit 20, the data conversion unit 12 converts the inspection data according to the standard of the data handled by the DUT 30. For example, the data conversion unit 12 receives data (slot numbers 1 and 2) of the company A input from the normality determination unit 20 (data input unit 21) and temporarily stores the data in the RAM 12B.

Then, when the DUT 30 of the B company is attached to the connector conversion unit 11, the data conversion unit 12 refers to the conversion table 12A and converts data (slot No. 1, 2, . . . ) of the A company in the RAM 12B into data (slot No. 1-1, 1-2, . . . ) of the B company. As a result, since the data of the A company is parameter-converted into the data of the B company, a difference in vendor can be absorbed.

The normality determination unit 20 includes a data input unit 21, a DB 22, a response processing unit 23, a data comparison unit 24, a determination unit 25, and a result display unit 26.

The data input unit 21 inputs the inspection data to the DUT 30 in response to the input operation from the maintenance person. The DB 22 stores inspection data unique to each vendor. The inspection data in the DB 22 is manually input by the maintenance person in advance.

When the DUT 30 of the company A is inspected, it is necessary to prepare data of the company A in the DB 22 in advance. In a case where a component of another vendor (company B, company C, . . . ) is mounted in a different slot in a housing in a local environment where the DUT 30 of the company A is scheduled to be mounted, it is desirable to prepare data of the other vendor in the DB 22 in advance.

Examples in which components of a plurality of vendors are attached to the same housing include a case where the component is a PKG (interface card) on which an optical module is mounted.

The response processing unit 23 receives a response from the DUT 30 to the inspection data input by the data input unit 21, and distributes the response to the data comparison unit 24 or the determination unit 25.

The data comparison unit 24 compares the inspection data in the DB 22 with the response data from the DUT 30, and confirms that the inspection data is normal when the inspection data matches the response data, and confirms that the inspection data is abnormal when the inspection data does not match the response data.

The determination unit 25 determines whether or not the response data from the DUT 30 includes an error. The determination unit 25 performs timer management of the presence or absence of a response from the DUT 30, and also detects a case where there is no response for a certain period of time (at the time of timeout) as an error. As a result, even when the DUT 30 fails and is not activated normally, an error can be appropriately detected.

The result display unit 26 displays the contents of the abnormality determined by the data comparison unit 24 or the determination unit 25 for each cause. The cause of the abnormality is, for example, a case where the optical module is broken or a case where there is an error in the mounted module type. As a result, the maintenance person can identify the cause from the alarm of the display content of the result display unit 26 and appropriately handle the abnormality.

The result display unit 26 may also display a maintenance action (component replacement, restart, or the like) necessary for coping with the content of the abnormality. The result display unit 26 may also display the contents of the LED display of the warning lamp of the DUT 30 by the DUT 30 in response to a notification from the DUT 30.

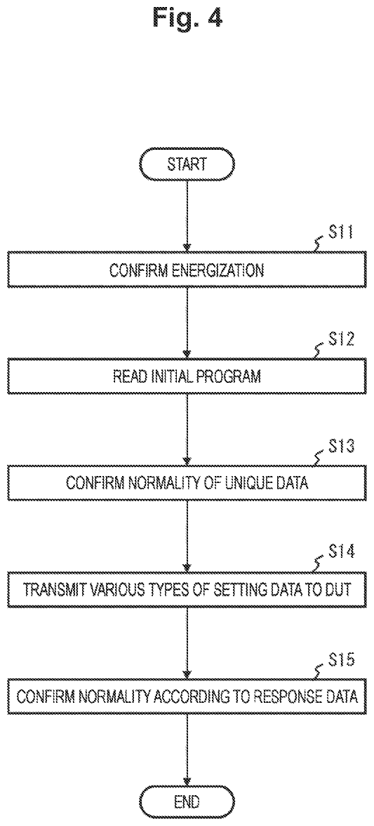

FIG. 4 is a flowchart illustrating processing of the component determination system 100. Before this flowchart is performed, the checker module unit 10 and the DUT 30 are connected via the connector conversion unit 11 conforming to the standard of the DUT 30.

The checker module unit 10 receives power supply from the power supply unit 50, energizes the DUT 30, and checks whether the power is correctly energized (S11).

The CPU 31 of the DUT 30 accesses the ROM 32 and reads an initial program (S12). First, when a boot program of a basic input/output system (BIOS) is read from the ROM 32 as an initial program, the CPU 31 initializes the RAM 33. Next, the CPU 31 reads an operating system (OS) and the first program operating on the OS as an initial program, and writes the read programs into the RAM 33.

The normality determination unit 20 (a processor that emulates the second program) confirms normality of the unique data of the DUT 30 (S13).

The normality determination unit 20 transmits various types of setting data to the DUT 30, and changes the setting of the DUT 30 to be operated by the communication device in the local environment (S14).

The normality determination unit 20 confirms normality according to the response data from the DUT 30 to the setting data in S14 (S15).

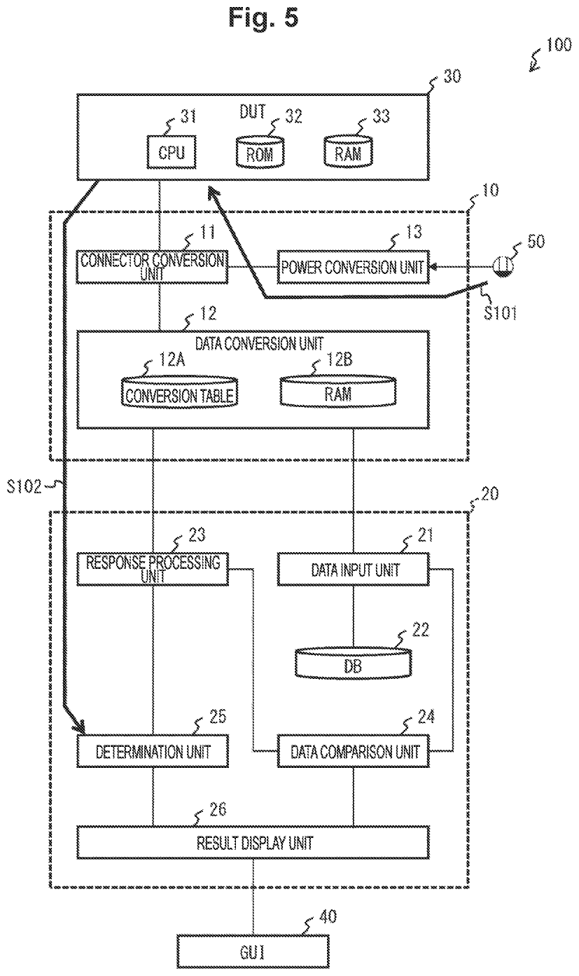

FIG. 5 is a configuration diagram illustrating details of energization confirmation processing (S11) and initial program reading processing (S12).

The checker module unit 10 receives a power supply signal from the power supply unit 50, energizes the DUT 30, and checks whether the power is correctly energized (S11 in FIG. 4, S101). The maintenance person can confirm energization by visually observing the warning lamp mounted on the DUT 30. For example, the warning lamp is turned on when the energization succeeds and turned off when the energization fails, but the presence or absence and usage (lighting, blinking, turning off, color, and the like) of the warning lamp may be variously implemented depending on a vendor.

The DUT 30 reads the initial program (S12 in FIG. 4), and responds to the normality determination unit 20 with activation state data indicating the result (normal activation or activation failure) (S102). The determination unit 25 receives the activation state data and displays information indicating normal activation or activation failure on the GUI 40 from the result display unit 26 to cause the maintenance person to confirm the state.

Not only when the activation state data indicating the activation failure is received, but also when the activation state data is not received, the determination unit 25 may display information indicating the activation failure on the result display unit 26.

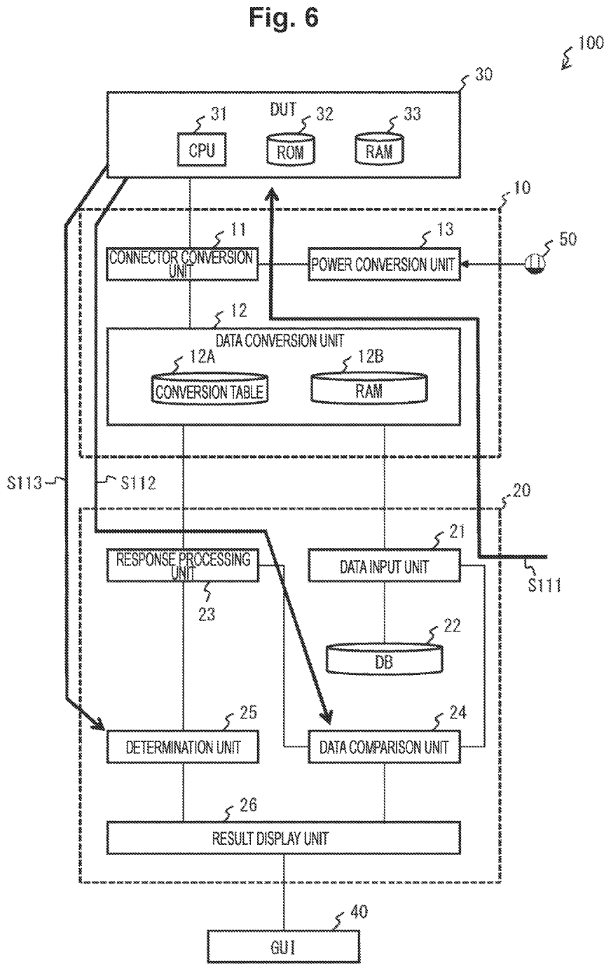

FIG. 6 is a configuration diagram illustrating details of normality confirmation (S13 of FIG. 4) of unique data.

The data input unit 21 receives the normality confirmation signal (S111) of the unique data, acquires the unique data of the DUT 30 with reference to the DB 22, and transmits the normality confirmation signal to the DUT 30. The normality confirmation signal is converted in the data conversion unit 12 so as to conform to the standard of the DUT 30.

The DUT 30 (first program) receives the normality confirmation signal (S111) of the unique data and responds to the checker module unit 10 with the unique data held by the DUT 30 (S112). The data comparison unit 24 compares the data stored in the DB 22 acquired by the data input unit 21 in S111 with the response data from the DUT 30 received from the checker module unit 10 in S112, and checks whether both pieces of unique data match each other.

The DUT 30 (first program) also responds to the checker module unit 10 with normality data indicating whether the unique data held by the DUT 30 is broken (S113). The determination unit 25 checks the presence or absence of an error response from the normality data received from the checker module unit 10 in S113.

Then, the result display unit 26 causes the GUI 40 to display the confirmation result in S112 (match or mismatch as a comparison result of the unique data) and the confirmation result in S113 (normality of the unique data), thereby causing the maintenance person to confirm abnormality of the unique data.

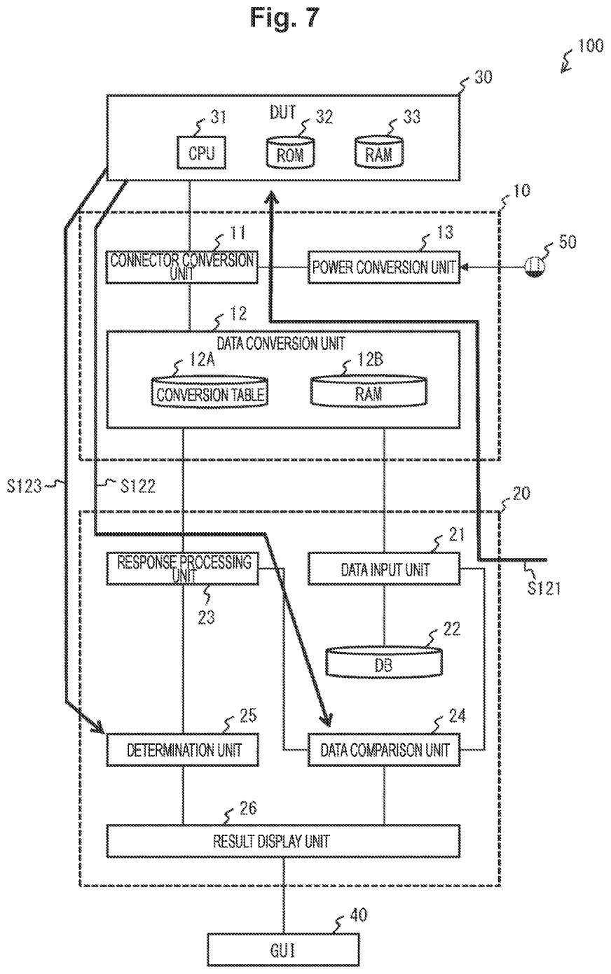

FIG. 7 is a configuration diagram illustrating details of various setting processing (S14 in FIG. 4) for the DUT 30 and normality confirmation processing (S15 in FIG. 4) according to setting data.

The data input unit 21 notifies the DUT 30 of various setting data read from the DB 22 (S121). The set data is converted in the data conversion unit 12 so as to conform to the standard of the DUT 30.

The DUT 30 (first program) receives the setting data (S121), reflects the setting data in the setting content of the DUT 30, and returns response data indicating the result (S122).

The data comparison unit 24 compares the setting data of the DB22 read in S121 with the response data from the DUT30, and checks whether or not they match (match). For example, a case where the following setting data and response data are compared is considered.
“Set IP address=192.168.0.1 to the first port of the DUT 30” as setting data in S121.
“Setting of IP address is completed” as response data of S122.

The data comparison unit 24 considers that the setting data and the response data in S122 are consistent with each other because the setting data and the expected data are consistent with each other although the setting data and the response data are not consistent with each other as character strings. The expected data is a model solution example of response data indicating that the setting data is correctly reflected in the DUT 30, and an input is received in advance in combination with the setting data.

For example, a case where the following setting data and response data are compared is considered.
“Set IP address=192.168.0.1 to the first port of the DUT 30” as setting data in S121.
“Setting of IP address is completed” and “IP address of first port=192.168.0.1” as response data in S122.

In this case, since the keyword “192.168.0.1” common to the setting data and the response data matches, the data comparison unit 24 considers that both the pieces of data match with each other. “IP address of first port=192.168.0.1” of the response data is, for example, an execution result of a command to sequentially read the current setting information of the DUT 30. This command is automatically issued by the data input unit 21 even when there is no explicit command instruction from the maintenance person.

The DUT 30 also responds to the checker module unit 10 with normality data indicating whether the setting data set in the DUT 30 is normally reflected (S123). The determination unit 25 checks the presence or absence of an error response from the normality data received from the checker module unit 10 in S123.

Then, the result display unit 26 causes the maintenance person to confirm the abnormality of the setting data by displaying the confirmation result (match and mismatch of the setting data) in S122 and the confirmation result (normality of the setting data) in S123 on the GUI 40.

### EFFECTS

The present invention is a component determination system 100 including
a checker module unit 10 that supplies power to a DUT 30 being connected, and
a normality determination unit 20 that transmits and receives inspection data to and from the DUT 30 via the checker module unit 10,
in which the checker module unit 10 includes
a connector conversion unit 11 that converts a connector such that the checker module unit 10 and the DUT 30 can be connected according to a standard of a connector used for connection to the DUT 30, and
a power conversion unit 13 that converts power into a standard capable of supplying power to the DUT 30 according to a standard of power used by the DUT 30, and
the normality determination unit 20 receives the inspection data indicating that the DUT 30 has been activated by supplying power to the DUT 30, and causes a GUI 40 to display a fact that the DUT30 has been activated.

As a result, it is possible to confirm the normality of the replacement component before the maintenance person carries the DUT 30 to the local environment and without providing the same inspection facility as that of the communication device in the local environment at the maintenance base.

Furthermore, by individually preparing the checker module unit 10 that absorbs the difference in standard for each vendor of the DUT 30 and the normality determination unit 20 that can be used in common by a plurality of vendors, one normality determination unit 20 can be shared by the plurality of checker module units 10, so that a low-cost inspection environment can be provided.

In the present invention, the normality determination unit 20
transmits inspection data to read unique data of the DUT 30 and respond, to the DUT 30 via the checker module unit 10, and
compares the unique data of the DUT 30 obtained as a response with the unique data of the DUT 30 read from the DB 22, and causes the GUI 40 to display a comparison result.

As a result, it is possible to inspect the unique data of the DUT 30 can be inspected from a maintenance base or the like before the maintenance person carries the DUT 30 to the local environment. Therefore, it is possible to prevent a mistake such as mistaking the DUT 30 to be replaced for another DUT 30.

In the present invention, the normality determination unit 20
transmits setting data used to operate the DUT 30 in a communication device in a local environment as inspection data to the DUT 30 via the checker module unit 10 to cause the DUT 30 to reflect the setting data in a setting content of the DUT 30 and to respond with a reflection result, and
causes the GUI 40 to display whether the reflection result of the DUT 30 obtained as a response is normal.

As a result, it is possible to check in advance whether the setting data of the DUT 30 can be correctly set from a maintenance base or the like before the maintenance person carries the DUT 30 to the local environment. Accordingly, it is possible to prevent an error such as a mistake of taking the DUT 30 of which the number of ports used by the communication device in the local environment is less than the number of ports.

In the present invention, the checker module unit 10 further includes a data conversion unit 12, and
when the data conversion unit 12 relays the inspection data transmitted and received between the DUT 30 and the normality determination unit 20, the data conversion unit 12 converts the inspection data according to a standard of data handled by the DUT 30.

As a result, even for a plurality of DUTs 30 having different data standards for each vendor and system, similar inspection can be performed by using the same inspection data from the same normality determination unit 20. Accordingly, since the maintenance person can perform the inspection without being conscious of the vendor of each DUT 30, the inspection cost can be reduced.

### REFERENCE SIGNS LIST

10 Checker module unit
11 Connector conversion unit
12 Data conversion unit
12A Conversion table
12B RAM
13 Power conversion unit
20 Normality determination unit
21 Data input unit
22 DB (storage unit)
23 Response processing unit
24 Data comparison unit
25 Determination unit
26 Result display unit
30 DUT (measurement target)
31 CPU
32 ROM
33 RAM
40 GUI (display device)
50 Power supply unit
100 Component determination system
110 Determination device

1. A determination device comprising,
a checker module unit comprising one or more processors, configured to supply power to a measurement target being connected, and
a normality determination unit, comprising the one or more processors, configured to transmit and receive inspection data to and from the measurement target via the checker module unit,
wherein the checker module unit includes:
a connector conversion unit configured to convert a connector such that the checker module unit and the measurement target can be connected according to a standard of a connector used for connection to the measurement target, and
a power conversion unit configured to convert into a standard capable of supplying power to the measurement target according to a standard of power used by the measurement target, and
the normality determination unit configured to receive the inspection data indicating that the measurement target has been activated by supplying power to the measurement target, and cause a display device to display a fact that the measurement target has been activated.

2. The determination device according to claim 1,
wherein the normality determination unit is configured to:
transmit the inspection data to read unique data of the measurement target and respond, to the measurement target via the checker module unit, and
compare the unique data of the measurement target obtained as a response with the unique data of the measurement target read from a storage unit, and cause the display device to display a comparison result.

3. The determination device according to claim 1,
wherein the normality determination unit is configured to:
transmit setting data used to operate the measurement target in a communication device in a local environment as the inspection data to the measurement target via the checker module unit to cause the measurement target to reflect the setting data in a setting content of the measurement target and to respond with a reflection result, and
cause the display device to display whether the reflection result of the measurement target obtained as a response is normal.

4. The determination device according to claim 1,
wherein the checker module unit further includes a data conversion unit, and
when the data conversion unit is configured to relay the inspection data transmitted and received between the measurement target and the normality determination unit, the data conversion unit is configured to convert the inspection data according to a standard of data handled by the measurement target.

5. A determination method implemented by a determination device,
wherein the determination device includes a checker module unit, comprising one or more processors, configured to supply power to a measurement target being connected, and
a normality determination unit configured to transmit and receive inspection data to and from the measurement target via the checker module unit,
the checker module unit includes:
a connector conversion unit configured to convert a connector such that the checker module unit and the measurement target is connected according to a standard of a connector used for connection to the measurement target, and
a power conversion unit configured to convert into a standard capable of supplying power to the measurement target according to a standard of power used by the measurement target, and
the normality determination unit configured to receive the inspection data indicating that the measurement target has been activated by supplying power to the measurement target, and cause a display device to display a fact that the measurement target has been activated.
